(19) United States
(12) Patent Application Publication
(10) Pub. No.: US 2018/0217589 A1
(43) Pub. Date: Aug. 2, 2018

(54) MOBILE TERMINAL AND METHOD OF CONTROLLING SAME

(71) Applicant: LG ELECTRONICS INC., Seoul (KR)

(72) Inventor: Jungki KIM, Seoul (KR)

(73) Assignee: LG ELECTRONICS INC., Seoul (KR)

(21) Appl. No.: 15/747,306

(22) PCT Filed: Oct. 28, 2015
(86) PCT No.: PCT/KR2015/011445

§ 371 Date: Jan. 24, 2018

(30) Foreign Application Priority Data
Jul. 30, 2015 (KR) 10-2015-0108266

(51) Int. Cl. G05D 1/00; G05D 1/10; H04N 7/18; H04N 5/232

(52) U.S. Cl. CPC G05D 1/0027; G05D 1/104; G05D 1/0016; G05D 1/0038; G06F 3/0488; H04N 7/185; H04N 5/23216; H04N 5/23293; G05D 1/0022; G05D 1/0033

(57) ABSTRACT

The present invention relates to a mobile terminal that is wirelessly connected to a master drone which images an outdoor environment including a plurality of slave drones having cameras. The mobile terminal includes: a wireless receiver for receiving control screen information comprised of the image of the outdoor environment; a display for outputting the control screen information; and a controller for transmitting a control command, for controlling a target slave drone selected from the plurality of slave drones on the basis of a touch applied on the control screen information, to the master drone. A preview image captured by the target slave drone based on the control command is output on the display.

### TECHNICAL FIELD

The present invention relates to a mobile terminal capable of controlling drones.

### BACKGROUND ART

A mobile terminal includes every device, which is provided with a battery and a display unit to output information thereon using power supplied from the battery, and is portable by a user. The mobile terminal includes a device for recording and playing back moving pictures (videos), a device for displaying a graphic user interface (GUI), and the like, and also includes a notebook, a mobile phone, glasses and a watch capable of displaying screen information, a game player, and the like.

As it becomes multifunctional, a mobile terminal can be allowed to capture still images or moving images, play music or video files, play games, receive broadcast and the like, so as to be implemented as an integrated multimedia player. Efforts are ongoing to support and increase the functionality of mobile terminals. Such efforts include software and hardware improvements, as well as changes and improvements in the structural components.

In recent years, various technologies for controlling an operation of an external device wirelessly connected to a mobile terminal are under development. For a drone of which flight is remotely controlled, when the drone is controlled by a remote control device provided with navigation keys, there is inconvenience that the user cannot easily recognize a position where the drone is flying.

### DISCLOSURE OF THE INVENTION

Therefore, an aspect of the present invention is to provide a mobile terminal capable of more intuitively controlling drones.

In order to accomplish the aspect of the present invention, there is provided a mobile terminal, which is wirelessly connected to a master drone for imaging an external environment including a plurality of slave drones each having a camera, the terminal including a wireless communication unit configured to receive control screen information including an image of the external environment, a display unit configured to output the control screen information, and a controller configured to transmit to the master drone a control command for controlling a selected target slave drone among the plurality of slave drones, in response to a touch applied to the control screen information. The controller may receive a preview image captured by the target slave drone on the basis of the control command, and output the preview image on the display unit.

In one embodiment related to the present invention, the terminal may further include a terminal body having the display unit mounted on one surface thereof, and a pair of sensing units disposed on both ends of the terminal body and configured to detect a user's hand supporting the terminal body. The controller may generate a different control command based on the user's hand detected by the pair of sensing units and a touch applied on the control screen information. Accordingly, the user can generate a flight control command of a slave drone by applying a touch on the display unit, and receive a preview image by selecting a slave drone.

In one embodiment of the present invention, the display unit may output a capture icon on the preview image, and the controller may store at least one of the preview image and the control screen information based on a touch applied on the capture icon. Accordingly, the user can selectively or simultaneously store control screen information and a preview image in which one area of the control screen information has been enlarged.

### Effects of the Invention

According to the present invention, a user can recognize a position of a slave drone captured by a master drone and receive a preview image captured at the position of the slave drone. This may allow the user to recognize a position and a capturing range of a slave drone even when the slave drone is flying at a position which is not visually recognizable.

### BRIEF DESCRIPTION OF THE DRAWINGS

FIG. 1A is a block diagram of a mobile terminal in accordance with one exemplary embodiment of the present invention.

FIGS. 1B and 1C are views of a mobile terminal according to the present invention, viewed from different directions.

FIGS. 2A and 2C are flowcharts illustrating a control method of a mobile terminal in accordance with one embodiment of the present invention.

FIG. 2B is a conceptual view illustrating the control method of FIG. 2A.

FIGS. 3A and 3B are conceptual views illustrating a feature of generating a flight control command or a capturing control command according to different embodiments.

FIGS. 4A and 4B are conceptual views illustrating a control method of a slave drone using a preview image.

FIGS. 5A to 5E are conceptual views illustrating a control method of selectively controlling control screen information and a preview image.

FIGS. 6A to 6C are conceptual views illustrating a control method of capturing images obtained by a plurality of drones in accordance with different embodiments.

FIGS. 7A and 7B are conceptual views illustrating a control method of sharing an image captured by a slave drone.

FIGS. 8A to 8C are conceptual views illustrating a control method of outputting a preview image in accordance with different embodiments.

FIG. 9 is a conceptual view illustrating a method of controlling a slave drone so as to fly over an area outside a capturing range of a master drone M.

### BEST MODE OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

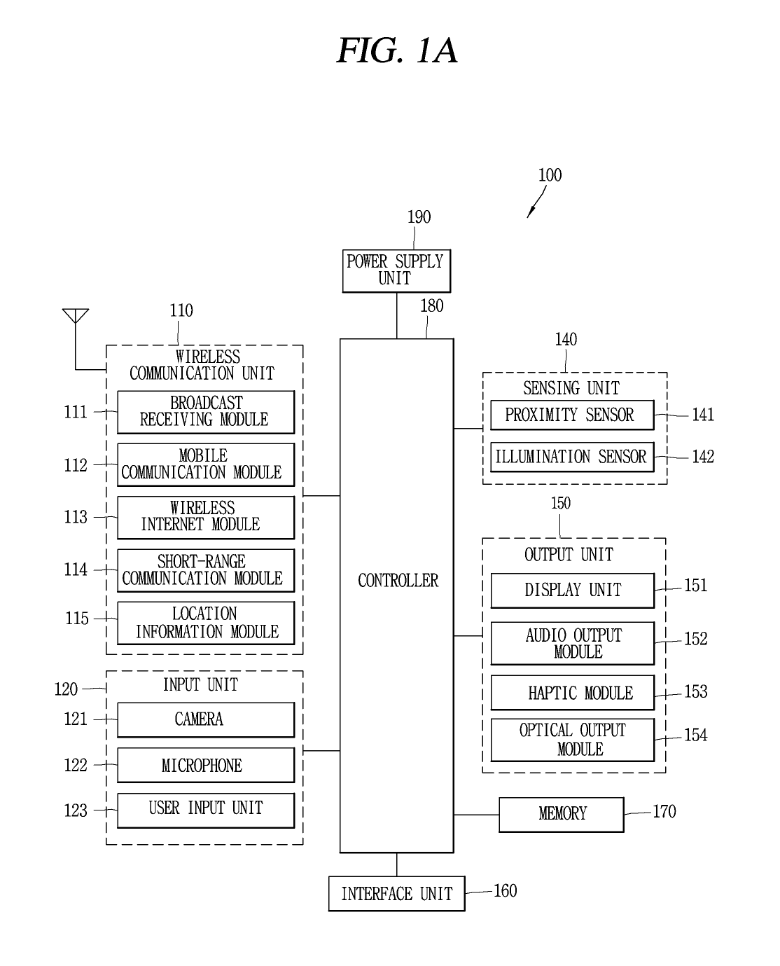

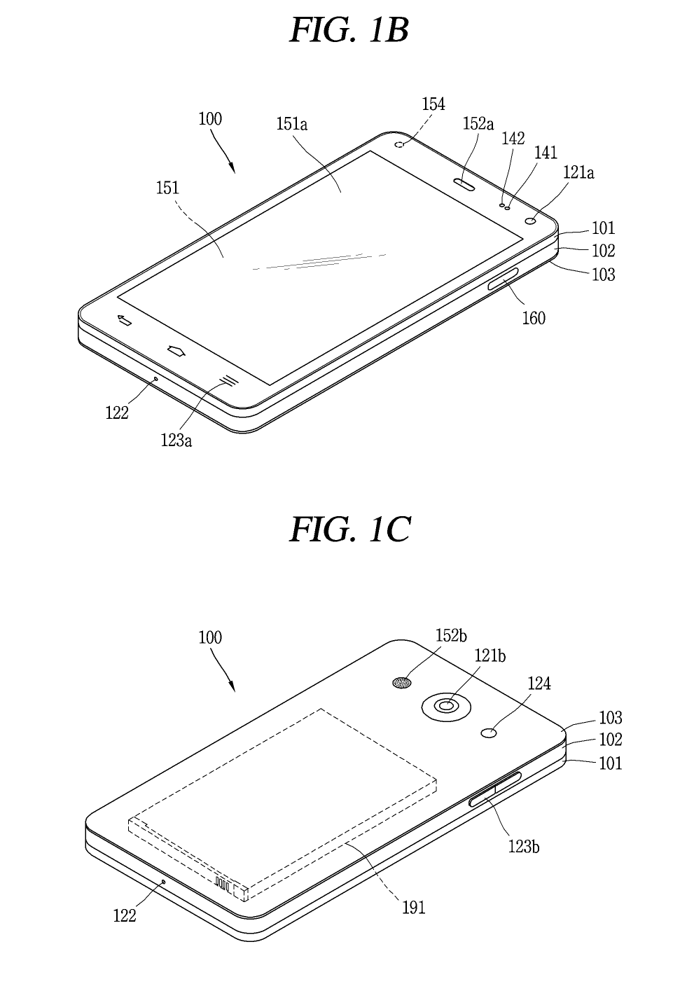

Referring to FIGS. 1A to 1C, FIG. 1A is a block diagram of a mobile terminal in accordance with one exemplary embodiment of the present invention, and FIGS. 1B and 1C are conceptual views illustrating one example of a mobile terminal, viewed from different directions.

The mobile terminal 100 may be shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, or communications between the mobile terminal 100 and an external server. Further, the wireless communication unit 110 may typically include one or more modules which connect the mobile terminal 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the mobile terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to implement a touch screen. The touch screen may function as the user input unit 123 which provides an input interface between the mobile terminal 100 and the user and simultaneously provide an output interface between the mobile terminal 100 and a user.

The interface unit 160 serves as an interface with various types of external devices that are coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). Application programs may be stored in the memory 170, installed in the mobile terminal 100, and executed by the controller 180 to perform an operation (or function) for the mobile terminal 100.

The controller 180 typically functions to control an overall operation of the mobile terminal 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1A, to execute an application program that have been stored in the memory 170. In addition, the controller 180 may control at least two of those components included in the mobile terminal to activate the application program.

The power supply unit 190 may be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least part of the components may cooperatively operate to implement an operation, a control or a control method of a mobile terminal according to various embodiments disclosed herein. Also, the operation, the control or the control method of the mobile terminal may be implemented on the mobile terminal by an activation of at least one application program stored in the memory 170.

Hereinafter, description will be given in more detail of the aforementioned components with reference to FIG. 1A, prior to describing various embodiments implemented through the mobile terminal 100.

First, regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules may be utilized to facilitate simultaneous reception of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

The wireless signal may include various types of data depending on a voice call signal, a video call signal, or a text/multimedia message transmission/reception.

The wireless Internet module 113 refers to a module for wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

Here, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position (or current position) of the mobile terminal. As an example, the location information module 115 includes a Global Position System (GPS) module, a Wi-Fi module, or both. For example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. If desired, the location information module 115 may alternatively or additionally function with any of the other modules of the wireless communication unit 110 to obtain data related to the position of the mobile terminal. The location information module 115 is a module used for acquiring the position (or the current position) and may not be limited to a module for directly calculating or acquiring the position of the mobile terminal.

Examples of such inputs include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. Meanwhile, the cameras 121 may be arranged in a matrix configuration to permit a plurality of images having various angles or focal points to be input to the mobile terminal 100. Also, the cameras 121 may be located in a stereoscopic arrangement to acquire left and right images for implementing a stereoscopic image.

The microphone 122 processes an external audio signal into electric audio (sound) data. The processed audio data can be processed in various manners according to a function being executed in the mobile terminal 100. If desired, the microphone 122 may include assorted noise removing algorithms to remove unwanted noise generated in the course of receiving the external audio signal.

The user input unit 123 is a component that permits input by a user. Such user input may enable the controller 180 to control operation of the mobile terminal 100. The user input unit 123 may include one or more of a mechanical input element (for example, a mechanical key, a button located on a front and/or rear surface or a side surface of the mobile terminal 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like, and generate a corresponding sensing signal. The controller 180 generally cooperates with the sending unit 140 to control operations of the mobile terminal 100 or execute data processing, a function or an operation associated with an application program installed in the mobile terminal based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data (or information) according to whether a touch with respect to a point on the touch screen is either a proximity touch or a contact touch.

A touch sensor senses a touch (or a touch input) applied to the touch screen (or the display unit 151) using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

Meanwhile, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize location information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors (TRs) at rows and columns to scan content received at the photo sensor using an electrical signal which changes according to the quantity of applied light. Namely, the photo sensor may calculate the coordinates of the physical object according to variation of light to thus obtain location information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

Also, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 may receive audio data from the wireless communication unit 110 or output audio data stored in the memory 170 during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceives, or otherwise experiences. A typical example of a tactile effect generated by the haptic module 153 is vibration. The strength, pattern and the like of the vibration generated by the haptic module 153 may be controlled by user selection or setting by the controller 180. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of the use of the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal therethrough. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control operations relating to application programs and the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100 under the control of the controller 180. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring to FIGS. 1B and 1C, the disclosed mobile terminal 100 includes a bar-like terminal body. However, the mobile terminal 100 may alternatively be implemented in any of a variety of different configurations. Examples of such configurations include watch type, clip-type, glasses-type, or a folder-type, flip-type, slide-type, swing-type, and swivel-type in which two and more bodies are combined with each other in a relatively movable manner, and combinations thereof. Discussion herein will often relate to a particular type of mobile terminal. However, such teachings with regard to a particular type of mobile terminal will generally apply to other types of mobile terminals as well.

Here, considering the mobile terminal 100 as at least one assembly, the terminal body may be understood as a conception referring to the assembly.

The mobile terminal 100 will generally include a case (for example, frame, housing, cover, and the like) forming the appearance of the terminal. In this embodiment, the case is formed using a front case 101 and a rear case 102. Various electronic components are interposed into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. In this case, a rear cover 103 is shown covering the electronic components, and this cover may be detachably coupled to the rear case 102. Therefore, when the rear cover 103 is detached from the rear case 102, the electronic components mounted on the rear case 102 are exposed to the outside.

As illustrated, when the rear cover 103 is coupled to the rear case 102, a side surface of the rear case 102 may partially be exposed. In some cases, upon the coupling, the rear case 102 may also be completely shielded by the rear cover 103. Meanwhile, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this case, a mobile terminal 100 having a uni-body is formed in such a manner that synthetic resin or metal extends from a side surface to a rear surface.

Meanwhile, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include a display unit 151, first and second audio output module 152a and 152b, a proximity sensor 141, an illumination sensor 142, an optical output module 154, first and second cameras 121a and 121b, first and second manipulation units 123a and 123b, a microphone 122, an interface unit 160, and the like.

Hereinafter, as illustrated in FIGS. 1B and 1C, description will be given of the exemplary mobile terminal 100 in which the front surface of the terminal body is shown having the display unit 151, the first audio output module 152a, the proximity sensor 141, the illumination sensor 142, the optical output module 154, the first camera 121a, and the first manipulation unit 123a, the side surface of the terminal body is shown having the second manipulation unit 123b, the microphone 122, and the interface unit 160, and the rear surface of the terminal body is shown having the second audio output module 152b and the second camera 121b.

However, those components may not be limited to the arrangement. Some components may be omitted or rearranged or located on different surfaces. For example, the first manipulation unit 123a may be located on another surface of the terminal body, and the second audio output module 152b may be located on the side surface of the terminal body other than the rear surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display module 151 may include at least one of a liquid crystal display (LCD), a thin film transistor-LCD (TFT LCD), an organic light-emitting diode (OLED), a flexible display, a three-dimensional (3D) display and an e-ink display.

The display unit 151 may be implemented using two display devices, according to the configuration type thereof. For instance, the mobile terminal 100 may be provided with a plurality of display units 151 arranged on one surface thereof in a spaced or integral manner, or arranged on different surfaces.

The display unit 151 may include a touch sensor that senses a touch with respect to the display unit 151 so as to receive a control command in a touch manner. Accordingly, when a touch is applied to the display unit 151, the touch sensor may sense the touch, and a controller 180 may generate a control command corresponding to the touch. Contents input in the touch manner may be characters, numbers, instructions in various modes, or a menu item that can be specified.

On the other hand, the touch sensor may be configured in a form of a film having a touch pattern and disposed between a window 151a and a display (not illustrated) on a rear surface of the window, or may be a metal wire directly patterned on the rear surface of the window. Alternatively, the touch sensor may be formed integrally with the display. For example, the touch sensor may be disposed on a substrate of the display, or may be provided inside the display.

In this way, the display unit 151 may form a touch screen together with the touch sensor, and in this case, the touch screen may function as the user input unit (123, see FIG. 1A). In some cases, the touch screen may replace at least some of functions of a first manipulation unit 123a.

The first audio output module 152a may be implemented as a receiver for transmitting a call sound to a user's ear and the second audio output module 152b may be implemented as a loud speaker for outputting various alarm sounds or multimedia playback sounds.

The window 151a of the display unit 151 may include a sound hole for emitting sounds generated from the first audio output module 152a. However, the present invention is not limited thereto, and the sounds may be released along an assembly gap between the structural bodies (for example, a gap between the window 151a and the front case 101). In this case, a hole independently formed to output audio sounds may not be seen or may otherwise be hidden in terms of appearance, thereby further simplifying the appearance of the mobile terminal 100.

The optical output module 154 may be configured to output light for indicating an event generation. Examples of such events may include a message reception, a call signal reception, a missed call, an alarm, a schedule alarm, an email reception, information reception through an application, and the like. When a user has checked a generated event, the controller 180 may control the optical output module 154 to stop the light output.

The first camera 121a may process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion. The first and second manipulation units 123a and 123b may employ any method if it is a tactile manner allowing the user to perform manipulation with a tactile feeling such as touch, push, scroll or the like The first and second manipulation units 123a and 123b may also be manipulated through a proximity touch, a hovering touch, and the like, without a user's tactile feeling.

The drawings are illustrated on the basis that the first manipulation unit 123a is a touch key, but the present disclosure may not be necessarily limited to this. For example, the first manipulation unit 123a may be configured with a mechanical key, or a combination of a touch key and a push key.

The content received by the first and second manipulation units 123a and 123b may be set in various ways. For example, the first manipulation unit 123a may be used by the user to input a command such as menu, home key, cancel, search, or the like, and the second manipulation unit 123b may be used by the user to input a command, such as controlling a volume level being output from the first or second audio output module 152a or 152b, switching into a touch recognition mode of the display unit 151, or the like.

On the other hand, as another example of the user input unit 123, a rear input unit (not shown) may be disposed on the rear surface of the terminal body. The rear input unit may be manipulated by a user to input a command for controlling an operation of the mobile terminal 100. The content input may be set in various ways. For example, the rear input unit may be used by the user to input a command, such as power on/off, start, end, scroll or the like, controlling a volume level being output from the first or second audio output module 152a or 152b, switching into a touch recognition mode of the display unit 151, or the like. The rear input unit may be implemented into a form allowing a touch input, a push input or a combination thereof.

The rear input unit may be disposed to overlap the display unit 151 of the front surface in a thickness direction of the terminal body. As one example, the rear input unit may be disposed on an upper end portion of the rear surface of the terminal body such that a user can easily manipulate it using a forefinger when the user grabs the terminal body with one hand. However, the present disclosure may not be limited to this, and the position of the rear input unit may be changeable.

When the rear input unit is disposed on the rear surface of the terminal body, a new user interface may be implemented using the rear input unit. Also, the aforementioned touch screen or the rear input unit may substitute for at least part of functions of the first manipulation unit 123a located on the front surface of the terminal body. Accordingly, when the first manipulation unit 123a is not disposed on the front surface of the terminal body, the display unit 151 may be implemented to have a larger screen.

On the other hand, the mobile terminal 100 may include a finger scan sensor which scans a user's fingerprint. The controller may use fingerprint information sensed by the finger scan sensor as an authentication means. The finger scan sensor may be installed in the display unit 151 or the user input unit 123.

The microphone 122 may be configured to receive the user's voice, other sounds, and the like. The microphone 122 may be provided at a plurality of places, and configured to receive stereo sounds.

The interface unit 160 may serve as a path allowing the mobile terminal 100 to interface with external devices. For example, the interface unit 160 may be at least one of a connection terminal for connecting to another device (for example, an earphone, an external speaker, or the like), a port for near field communication (for example, an Infrared DaAssociation (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b may be further mounted to the rear surface of the terminal body. The second camera 121b may have an image capturing direction, which is substantially opposite to the direction of the first camera unit 121a.

The second camera 121b may include a plurality of lenses arranged along at least one line. The plurality of lenses may be arranged in a matrix form. The cameras may be referred to as an ‘array camera.’ When the second camera 121b is implemented as the array camera, images may be captured in various manners using the plurality of lenses and images with better qualities may be obtained.

The flash 124 may be disposed adjacent to the second camera 121b. When an image of a subject is captured with the camera 121b, the flash 124 may illuminate the subject.

The second audio output module 152b may further be disposed on the terminal body. The second audio output module 152b may implement stereophonic sound functions in conjunction with the first audio output module 152a, and may be also used for implementing a speaker phone mode for call communication.

At least one antenna for wireless communication may be disposed on the terminal body. The antenna may be embedded in the terminal body or formed in the case. For example, an antenna which configures a part of the broadcast receiving module 111 (see FIG. 1A) may be retractable into the terminal body. Alternatively, an antenna may be formed in a form of film to be attached onto an inner surface of the rear cover 103 or a case including a conductive material may serve as an antenna.

The terminal body is provided with a power supply unit 190 (see FIG. 1A) for supplying power to the mobile terminal 100. The power supply unit 190 may include a batter 191 which is mounted in the terminal body or detachably coupled to an outside of the terminal body.

The battery 191 may receive power via a power cable connected to the interface unit 160. Also, the battery 191 may be (re)chargeable in a wireless manner using a wireless charger. The wireless charging may be implemented by magnetic induction or electromagnetic resonance.

On the other hand, the drawing illustrates that the rear cover 103 is coupled to the rear case 102 for shielding the battery 191, so as to prevent separation of the battery 191 and protect the battery 191 from an external impact or foreign materials. When the battery 191 is detachable from the terminal body, the rear case 103 may be detachably coupled to the rear case 102.

An accessory for protecting an appearance or assisting or extending the functions of the mobile terminal 100 may further be provided on the mobile terminal 100. As one example of the accessory, a cover or pouch for covering or accommodating at least one surface of the mobile terminal 100 may be provided. The cover or pouch may cooperate with the display unit 151 to extend the function of the mobile terminal 100. Another example of the accessory may be a touch pen for assisting or extending a touch input onto a touch screen.

The mobile terminal according to the present invention performs wireless communication with drones and controls functions of the drones. Here, a drone is an aircraft without using a runway, and may be provided with various functions such as transportation of objects, capturing of images, searching for low-altitude settlement, etc. in a relatively lightweight small body. The mobile terminal of the present invention generates a control command for controlling the flight of the drone, and a control command for controlling a camera, which captures an external environment during flight, among various electronic components mounted in the drone.

Hereinafter, a control method for controlling various functions of the drones using the mobile terminal will be described.

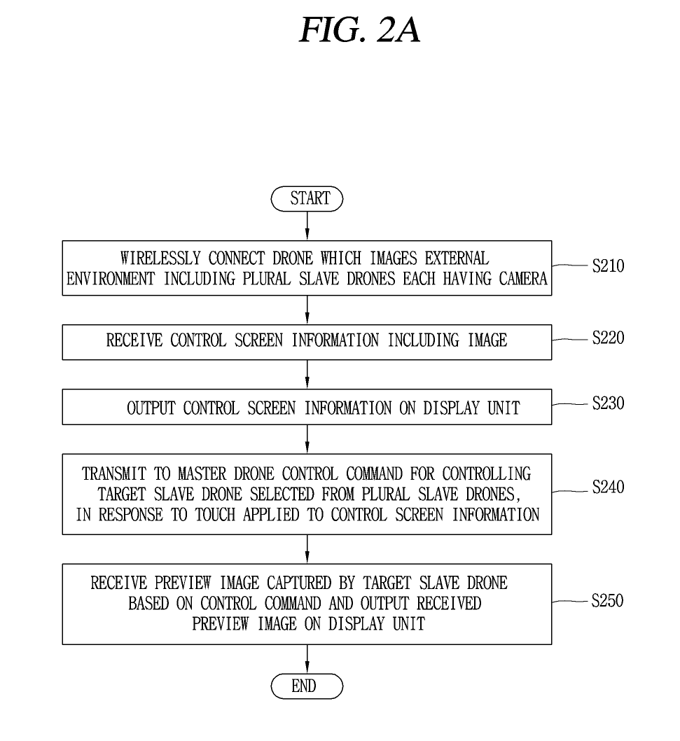

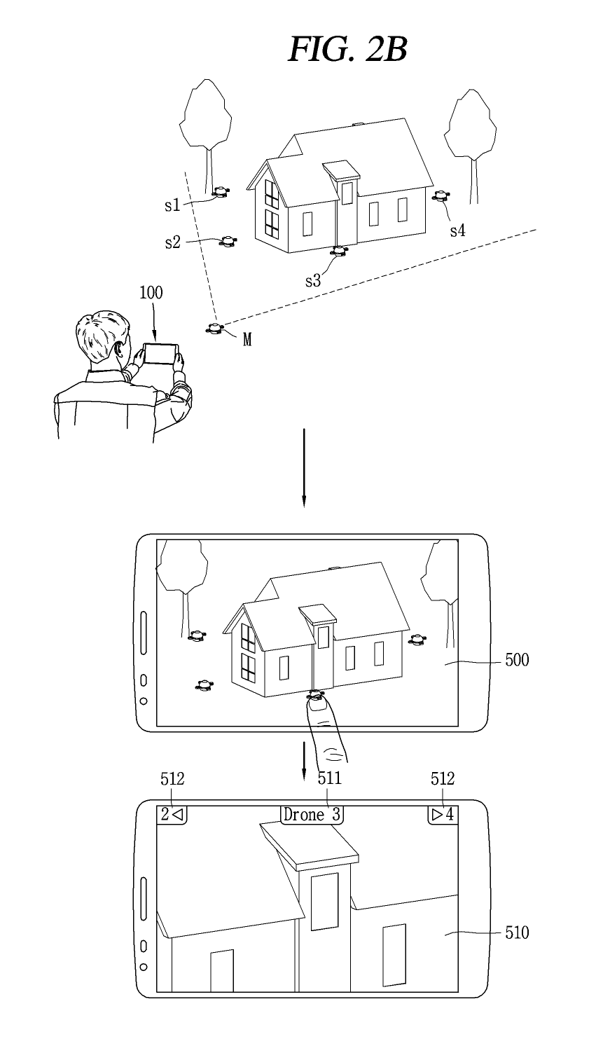

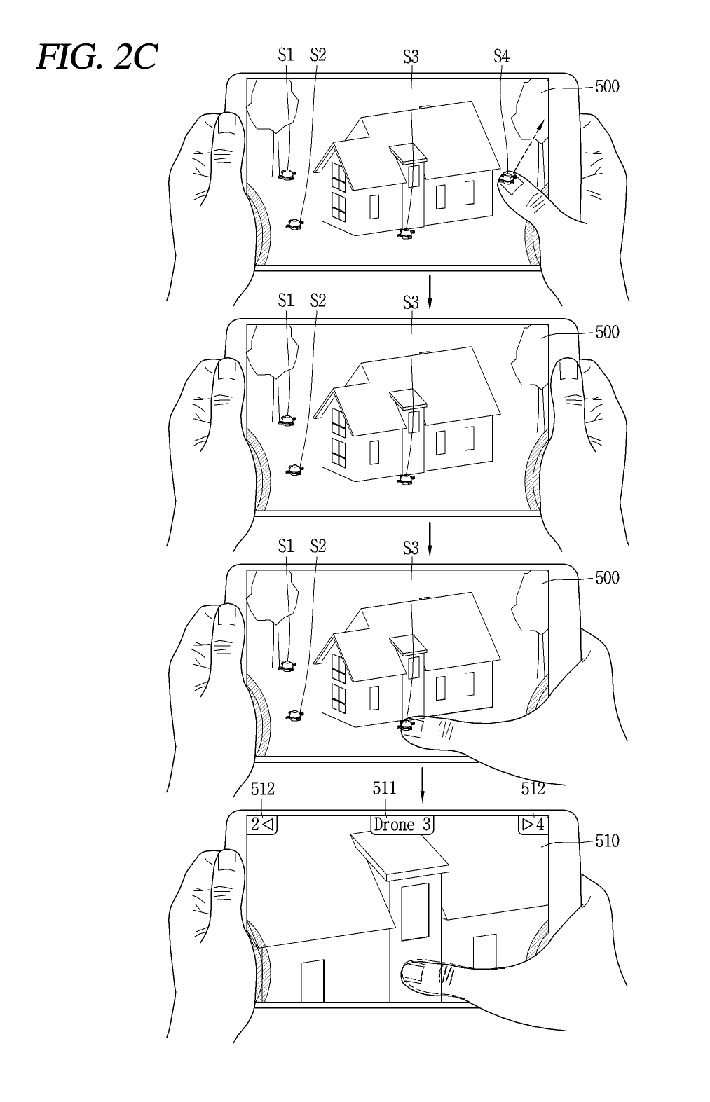

FIG. 2A is a flowchart illustrating a method of controlling a mobile terminal according to one embodiment of the present invention, and FIGS. 2B and 2C are conceptual views illustrating the control method according to the present invention.

The wireless communication unit 110 is wirelessly connected to a master drone M that images an external environment including a plurality of slave drones each equipped with a camera (S210). Referring to FIG. 2B, the master drone M captures an external environment including first to fourth slave drones s1, s2, s3 and s4. The master drone M may detect all of the first to fourth slave drones s1, s2, s3 and s4 through an angle of view of a camera mounted thereon.

Positions of the first to fourth slave drones s1, s2, s3 and s4 may be recognized based on an image captured by the master drone M. The master drone M may be fixed at a preset position and detect changes in position of the first to fourth slave drones s1, s2, s3 and s4. The number of slave drones in the present invention is not limited to this. In addition, one of the plurality of drones included in the present invention may be decided as the master drone M, and the master drone M may be changed by a user setting. It is preferable that the first to fourth slave drones s1, s2, s3 and s4 are spaced apart from one another.

The controller receives control screen information including an image captured by the master drone M (S220). The control screen information may include information on a relative position between the master drone M and each slave drone, distance information between the slave drones, information on a relative position of each slave drone with respect to a specific object included in the image, and the like. Each of the plurality of slave drones detected by the master drone M has distinguishable tag information. That is, the master drone M may distinguish the plurality of slave drones detected by the camera using the different tag information.

The control screen information may include tag information related to each of the plurality of slave drones. The controller may receive an image including the slave drones and the tag information on the slave drones as the control screen information.

The display unit 151 outputs the control screen information 500 (S230).

The control screen information 500 is substantially the same as the image captured by the master drone M. The wireless communication unit 110 may receive the control screen information from the master drone M according to a preset period or receive the control screen information when the slave drone or the external environment is changed. Accordingly, the user may receive postures of the slave drones captured by the master drone M in real time.

The control screen information 500 includes first to fourth objects S1, S2, S3 and S4 corresponding to the first to fourth slave drones s1, s2, s3 and s4. The controller may generate a control command on the display unit 151, in response to a touch applied to the first to fourth objects S1, S2, S3, and S4.

The controller 180 transmits a control command for controlling a selected target slave drone among the plurality of slave drones to the master drone M based on a touch applied to the control screen information 500 (S240). The controller 180 receives a preview image captured by the target slave drone on the basis of the control command, and outputs the preview image on the display unit 151.

When a touch applied to the control screen information is applied to the first to fourth objects S1, S2, S3 and S4, the controller 180 may select one of the first to fourth objects S1, S2, S3 and S4 and transmit a control command to the master drone M. Alternatively, the controller 180 may transmit to the master drone M information (coordinates) related to a touch point to which a touch has been applied on the control screen information, and a control command.

The master drone M transmits the control command to the target slave drone selected by the touch. The master drone M may select one of a plurality of master drones M based on the information related to the touch point and transmit the control command to the selected drone. The controller 180 of the mobile terminal may select a plurality of slave drones based on the touch.

For example, when a specific touch is applied to an object corresponding to the slave drone, the controller 180 may generate (form) a control command for transmitting a preview image captured by the slave drone. When the control command is transmitted to the selected third drone s3 by the master drone M, the master drone M receives a preview image captured by the third drone s3 and transmits the preview image to the mobile terminal 100. Alternatively, the master drone M may receive preview images in real time from the plurality of drones, and selectively transmit a preview image captured by a selected target slave drone to the mobile terminal.

The display unit 151 outputs the preview image 510. That is, the display unit 151 may output an image captured by the selected drone, in response to a touch applied to one of the plurality of objects corresponding to the plurality of drones. The preview image 510 is fully output on the display unit 151.

The display unit 151 outputs an index image 511 indicating the selected slave drone on the preview image 510. The index image 511 may correspond to a name assigned to the slave drone, unique information related to the slave drone, and the like. In addition, the controller 180 may receive an image captured by another slave drone of the plurality of slave drones, in response to a touch applied to one of control icons 512 included in the preview image 510.

For example, when the plurality of drones are given an order, the controller 180 receives a touch for selecting slave drones before and after the selected target slave drone. If the selected slave drone corresponds to the last in order, a part of the control icons 512 may not be output. When a touch is applied to the icon 512, the preview image 510 is switched to another preview image captured by another slave drone.

According to the present invention, the user can recognize a position of a slave drone captured by the master drone M, and receive a preview image captured at the position of the slave drone. Accordingly, the user can recognize a position and a capturing range of the slave drone even when the slave drone is flying at a position which is not visually recognizable.

Hereinafter, a control method of controlling a slave drone through the master drone M will be described with reference to FIG. 2C. The control screen information 500 includes the first to fourth objects S1, S2, S3 and S4 corresponding to the first to fourth slave drones s1, s2, s3 and s4. According to one embodiment, when a touch is applied to two areas on the display unit 151, the controller 180 generates a control command for controlling the flight of the first to fourth slave drones s1, s2, s3 and s4.

Alternatively, the mobile terminal 100 may include sensing units disposed on both end portions of the terminal body to detect a contact by a user or pressure for supporting the terminal body. The controller 180 may generate different types of control commands through the sensing units depending on whether the user supports the terminal body with both hands or with one hand.

For example, the controller 180 selects one of the plurality of slave drones and generates a control command for controlling a flight of the selected one drone when a touch is applied onto the display unit 151 while the terminal body is supported with one hand, which is detected through the sensing units. The controller 180 selects the fourth slave drone based on a touch applied to the fourth object S4. When a drag touch is applied to the control screen information while the touch is applied to the fourth object S4, the controller 180 generates a flight control command such that the fourth slave drone flies along a flying path corresponding to a path to which the drag touch is applied. The flight control command is transmitted to the fourth slave drone through the master drone M.

While the terminal body is detected to be supported with both hands, the controller 180 may generate a flight control command of the slave drones, and the display unit 151 may continuously output the control screen information.

When the sensing units detect that the terminal body is supported with one hand, the controller 180 generates a control command for controlling a preview image transmitted by the slave drone, in response to a touch applied to the display unit 151.

The controller 180 selects the third object S3, in response to the touch applied to the display unit 151, among the plurality of objects included in the control screen information. Meanwhile, in this case, when the main body is supported by both hands, a control command for moving the third slave s3 is generated. The controller 180 receives the preview image 510 captured by the third slave drone s3 based on the touch and the display unit 151 outputs the preview image 510. That is, the controller 180 may generate a control command for receiving an image captured by the third slave drone based on the touch.

The controller 180 generates a control command for capturing and storing the preview image 510, in response to a specific touch applied to the preview image 510 captured by the third slave drone s3.

According to this embodiment, a different control command may be generated by a touch applied to the object while the terminal body is supported by both hands or one hand. Accordingly, the user can change the position of the slave drone or activate a function (camera function) of the slave drone by applying substantially the same touch.

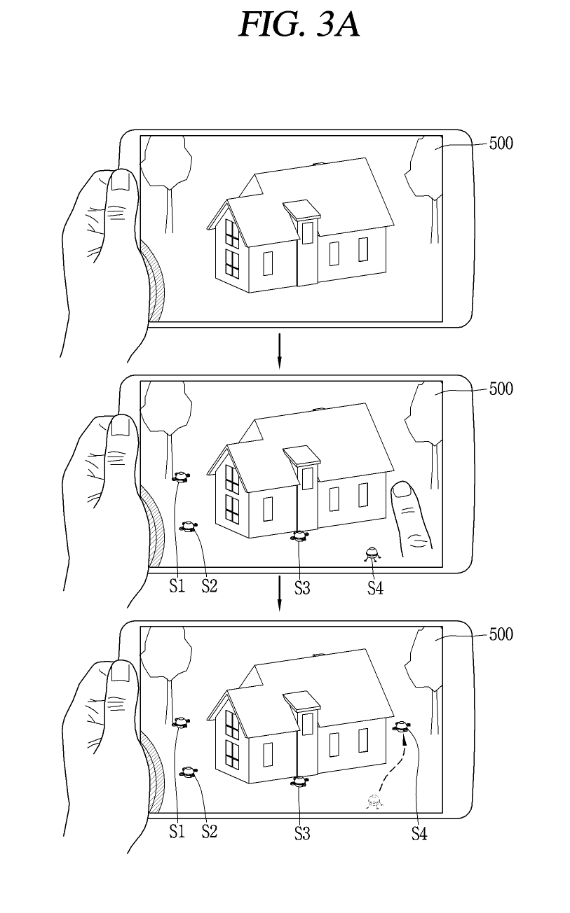

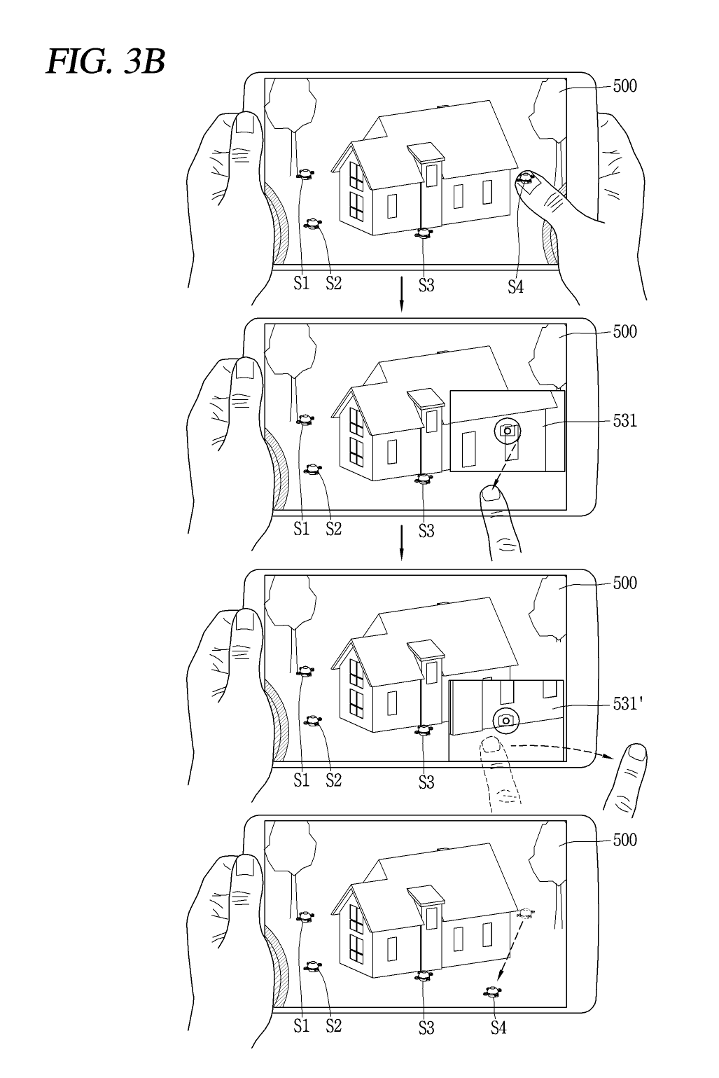

FIGS. 3A and 3B are conceptual views illustrating features of generating a flight control command or a capturing control command according to another embodiment.

Referring to FIG. 3A, the display unit 151 outputs control screen information 500 that does not include the first to fourth objects. That is, the master drone M deletes the objects corresponding to the slave drones on the captured image to transmit to the mobile terminal 100. The display unit 151 receives a touch on every area of the control screen information 500. The display unit 151 may display the plurality of objects corresponding to the plurality of slave drones on the control screen information 500 when the touch is received.

Although not illustrated in detail, the controller 180 may select a slave drone corresponding to one of the first to fourth objects S1, S2, S3 and S4 in a specific area to which the touch is applied, and generate a flight control command of the slave drone.

Meanwhile, when there is no object (and slave drone) corresponding to the specific area to which the touch is applied, the controller 180 generates a flight control command to be applied to any one of the plurality of slave drones. The flight control command corresponds to a control command for controlling the slave drone to be positioned in one area of an external environment corresponding to the touch-applied area. The flight control command may include location information related to an external environment based on coordinates of the applied touch on the control screen information. The controller 180 transmits the flight control command to the master drone M. The master drone M transmits the flight control command to a slave drone, which is located closest to the location information, based on the location information. Accordingly, the slave drone may be arranged at a position designated by the user.

Although not specifically illustrated, a preview image captured by the slave drone moved based on the flight control command may be received in the mobile terminal.

Referring to FIG. 3B, when a touch is applied to the fourth object S4 while the terminal body is supported by both hands, the controller 180 receives a preview image captured by the fourth slave drone s4. The display unit 151 outputs a thumbnail image 531 corresponding to the preview image on the control screen information 500. The thumbnail image 531 may be displayed to overlap the fourth object S4.

The controller 180 controls the display unit 151 to move an output position of the thumbnail image 531 based on a continuous touch (for example, a drag touch) applied to the thumbnail image 531. A preview image of a thumbnail image 531′ displayed on the thumbnail image 531 is changed while the output position of the thumbnail image 531 is changed. That is, the controller 180 generates a flight control command to move the fourth slave drone in response to the change of the output position of the thumbnail image 531.

That is, the controller 180 transmits the flight control command for moving the fourth slave drone s4 to the master drone M in real time, in response to the touch applied to the thumbnail image 531, and the master drone M receives a preview image captured by the moving fourth slave drone in real time to transmit to the mobile terminal. Accordingly, the user can confirm in real time the captured image which is captured by the fourth slave drone s4 during the movement.

When the touch is released from the thumbnail image 531′, the controller 180 controls the display unit 151 not to output the thumbnail image 531′ any more and output the fourth object S4 corresponding to the moved fourth slave drone s4.

According to this embodiment, the user can check in real time an image, which is captured by a slave drone while moving, identify an area to be captured as a real preview image, and designate a position of the slave drone.

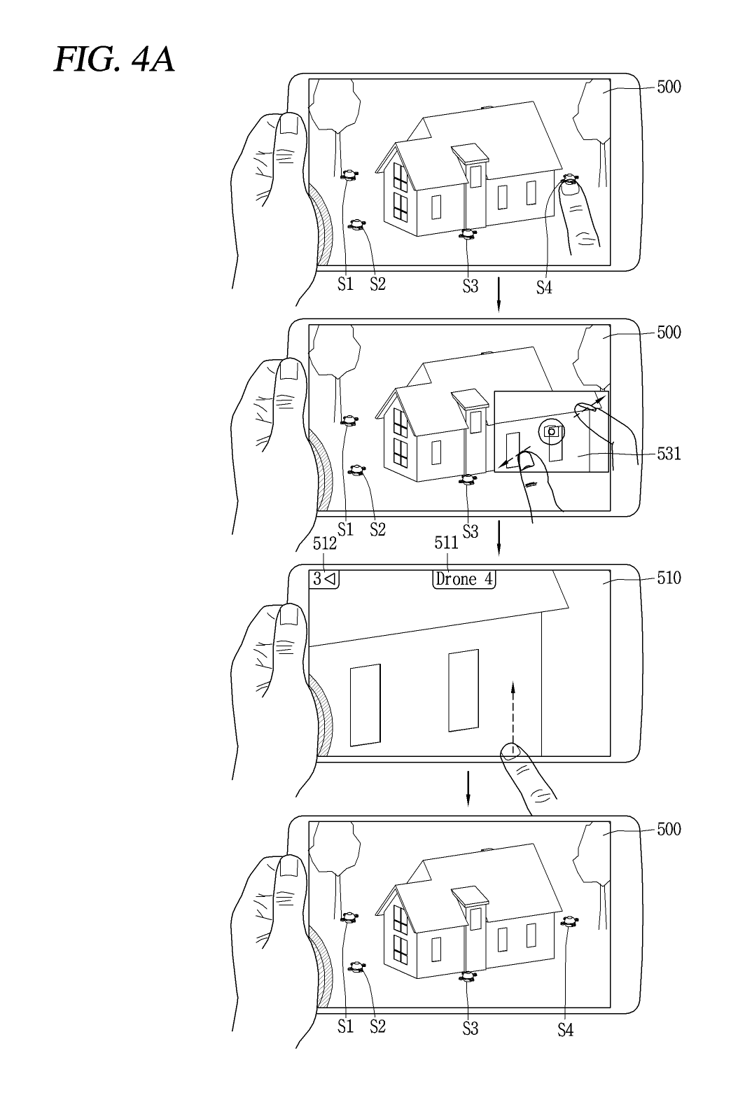

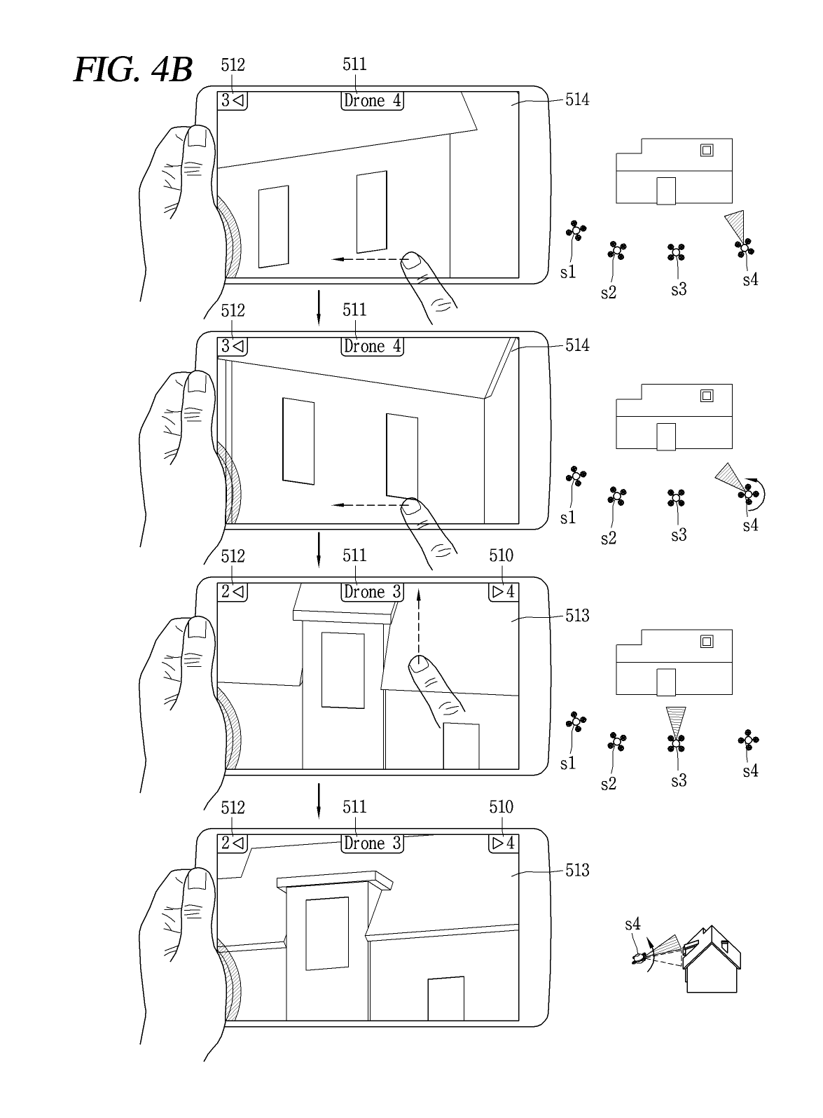

FIGS. 4A and 4B are conceptual views illustrating a method of controlling a slave drone using a preview image.

Referring to FIG. 4A, the display unit 151 outputs the first to fourth objects S1, S2, S3 and S4 corresponding to the first to fourth slave drones s1, s2, s3 and s4 on the control screen information 500. The controller 180 selects one slave drone based on a touch applied to any one of the plurality of objects. The display unit 151 outputs a thumbnail image 531, which is a preview image captured by the selected one slave drone, on the control screen information 500. For example, when a touch is applied to the fourth object S4, a request signal for requesting a preview image of the fourth object S4 may be transmitted to the master drone M, and the preview image may be transmitted from the master drone M. The thumbnail image 531 is displayed to overlap the fourth object S4.

The controller 180 may control the display unit 151 not to display the thumbnail image 531 any more when a touch is applied to the thumbnail image 531 or one area of the control screen information 500.

When a specific touch is applied to the thumbnail image 531, the controller 180 controls the display unit 151 to switch the control screen information 500 to the preview image 510. For example, the specific touch may correspond to a pinch-out touch input applied in a direction away from each other, but the present invention is not limited thereto.

The controller 180 controls the display unit 151 to switch the preview image 510 to the control screen information 500 when a specific touch is applied to the display unit 151 while the preview image 510 is output. Here, the specific touch may correspond to a drag touch input applied in an opposite direction to an output direction of the preview image 510, or, although not illustrated, may correspond to a pinch-in touch input.

According to this embodiment, the user can receive in various forms an image captured by a selected slave drone based on various types of touch inputs.

Hereinafter, a control method of changing a capturing range of a slave drone will be described with reference to FIG. 4B. The display unit 151 outputs a fourth preview image 514 captured by a selected slave drone (the fourth slave drone). An index image 511 indicating the fourth slave drone and a control icon 512 for controlling a change to another slave drone are displayed together with the fourth preview image 514.

The controller 180 generates a control command for changing a capturing range of the fourth slave drone s4, in response to a touch of one direction applied on the fourth preview image 514. The control command is transmitted to the fourth slave drone s4 by the master drone M. A capturing range of a camera of the fourth slave drone s4 may be changed or the fourth slave drone s4 may be rotated in a specific direction, based on the control command.

Meanwhile, when the change of the capturing range of the fourth slave drone reaches a limit due to an additional application of the touch applied in the one direction, the controller 180 controls the display unit 151 to output a third preview image 513 captured by the third slave drone s3. Then, control icons 512, 510 are output.

That is, the controller 180 may change a capturing range of a selected one slave drone or change a slave drone to provide the displayed preview image, based on a touch applied to the preview image.

Meanwhile, the controller 180 transmits a control command for changing a capturing direction of the selected slave drone to correspond to another direction when a touch is applied in another direction intersecting with the one direction. For example, when the another direction is a direction opposite to the output direction of the display unit 151, the controller 180 may transmit a control command such that the camera of the slave drone captures a relatively upward direction.

According to this embodiment, the user can change a capturing range of a slave drone that has captured a currently-output preview image, in response to a touch applied to the preview image.

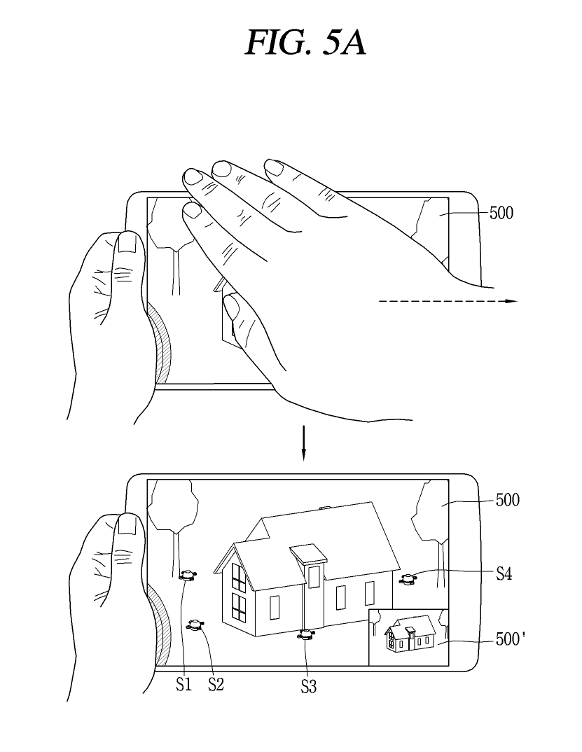

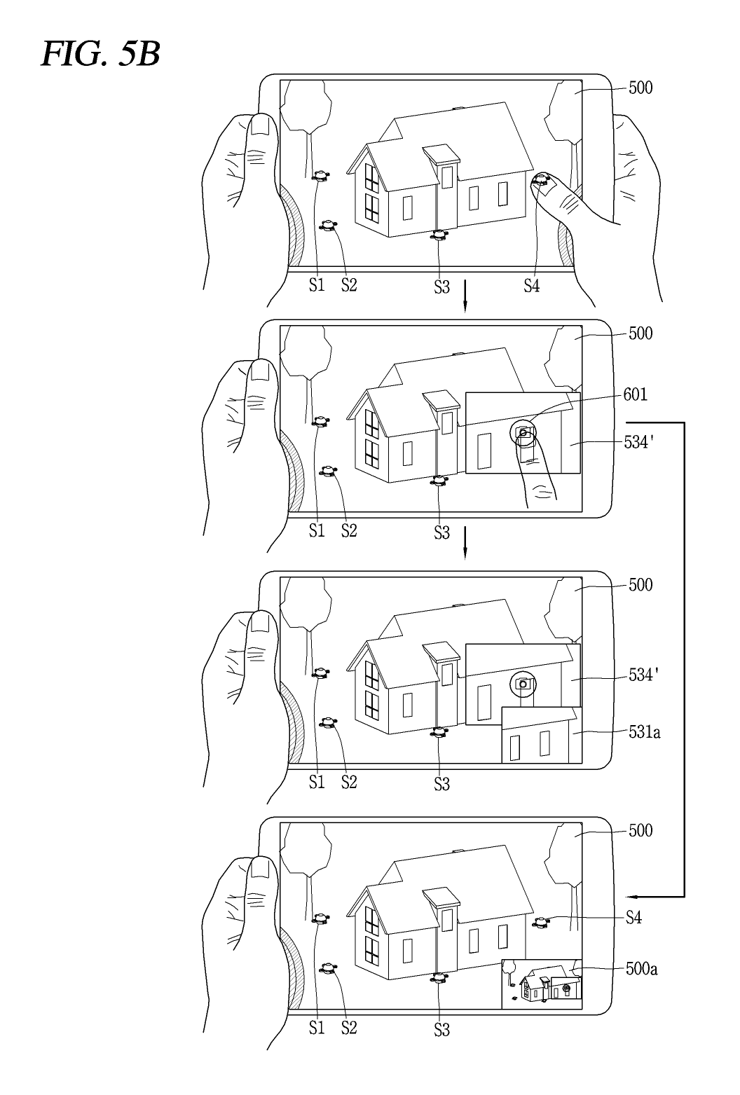

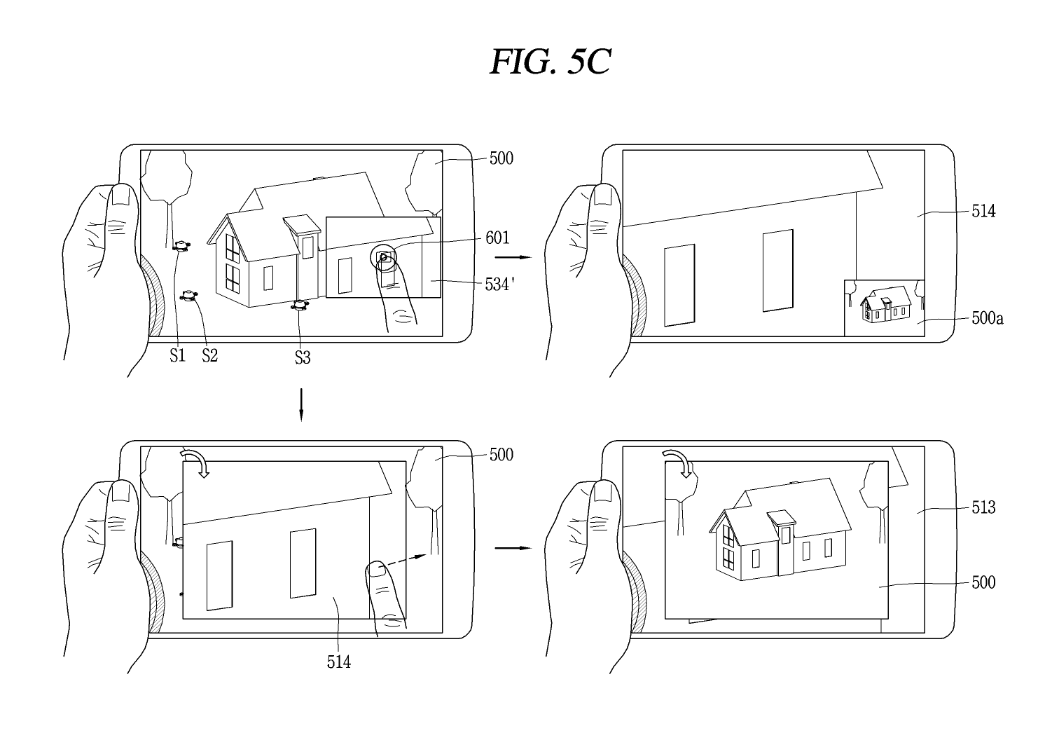

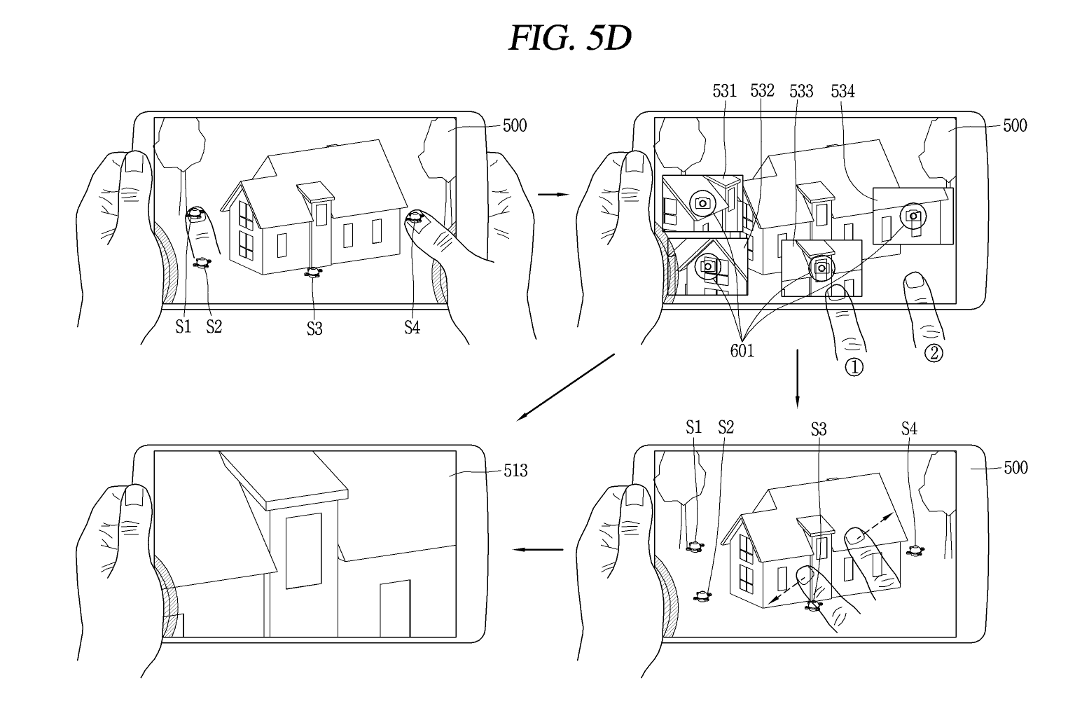

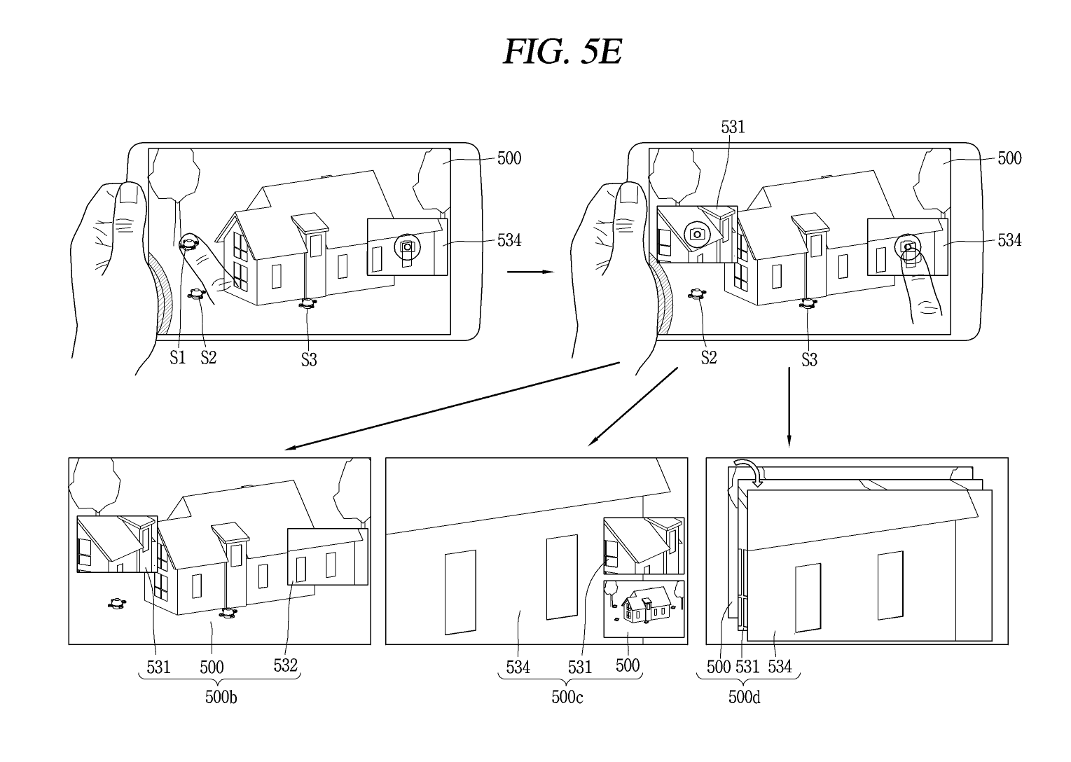

FIGS. 5A to 5E are conceptual views illustrating a method of selectively controlling control screen information and a preview image.

Referring to FIG. 5A, when a preset gesture is detected while the control screen information 500 including the first to fourth objects S1, S2, S3 and S4 is output, the controller 180 may control a control image 500′ to be stored. Here, the control image 500′ corresponds to an image in which the output of the first to fourth objects S1, S2, S3 and S4 is limited. An area where the first to fourth objects S1, S2, S3 and S4 are displayed may be merged with preview images captured by the first to fourth slave drones s1, s2, s3 and s4.

Although not specifically illustrated, the control image 500′ may be stored together with location information on each slave drone. For example, when a touch is applied to the control image 500′, information related to the plurality of objects may be output. Accordingly, the user can acquire a full image without including an image of any slave drone, of an image captured by the master drone M.

Referring to FIG. 5B, the controller 180 outputs a fourth thumbnail image 534′, which is configured as a fourth preview image captured by the fourth slave drone s4, in response to a touch applied to the fourth object S4. The fourth thumbnail image 534′ is output on the fourth object S4. The display unit 151 outputs a capture icon 601 on the fourth thumbnail image 534′.

The controller 180 may control the memory 170 to store only the thumbnail image 534′, in response to a touch applied to the capture icon 601. When the fourth thumbnail image 534′ is stored in the memory 170, the display unit 151 outputs a stored image 531a indicating that the fourth thumbnail image 534′ has been stored.

Alternatively, the controller 180 controls the memory 170 to store the fourth thumbnail image 534′ together with the control screen information 500, in response to the touch applied to the capture icon 601. The memory 170 may store a merged image in which the fourth thumbnail image 534′ is output in a manner of overlapping the control screen information 500. The display unit 151 outputs a stored image 500a when the memory 170 completely stores the merged image. Meanwhile, the controller 180 may control the memory 170 to store the fourth thumbnail image 534′ and the control screen information 500, respectively. In this case, the user can save the control screen information 500 with the fourth thumbnail image 534′ output thereon at once.

Referring to FIG. 5C, the display unit 151 outputs the fourth thumbnail image 534′, which is configured as the preview image captured by the fourth slave drone s4, on the control screen information 500, and outputs the capture icon 601 on the fourth thumbnail image 534′.

The controller 180 may control the memory 170 to store at least one of the control screen information 500 and the fourth preview image 514, in response to a touch applied to the capture icon 601. The controller 180 may output the fourth preview image 514 on the full display unit 151, and control the display unit 151 to output the stored image 500a indicating that the control screen information 500 has been stored.

Meanwhile, the controller 180 controls the memory 170 to store the fourth preview image 514 and the control screen information 500 together, in response to a touch applied to the capture icon 601. The controller 180 controls the display unit 151 to output the control screen information 500 and the fourth preview image 514 in an overlapped state. The control screen information 500 and the fourth preview image 514 may be displayed in a manner that their overlapped state is indicated, and an indicator indicating the overlap may be output together.

The controller 180 may control the display unit 151 to output the control screen information 500 on the fourth preview image 514, in response to a touch applied while the control screen information 500 and the fourth preview image 514 are output.

Accordingly, the user can store the preview image overlapped on the control screen information, and selectively output the stored preview image.

Referring to FIG. 5D, the controller 180 controls the display unit 151 to output first to fourth thumbnail images 531, 532, 533 and 534, in response to a touch applied to at least two areas of the first to fourth objects S1, S2, S3 and S4. For example, in case where tag information related to the plurality of slave drones is given in a sequential manner, the controller 180 selects the first to fourth slave drones s1, s2, s3 and s4 when a touch is applied to each of the first and fourth objects S1 and S4. The controller 180 controls the display unit 151 to output the first to fourth thumbnail images 531, 532, 533 and 534 on the control screen information 500. Output areas of the plurality of thumbnail images may overlap output areas of the objects. The display unit 151 may output the capture icon 601 on each of the thumbnail images.

When a touch is applied to the third thumbnail image 533 (1), the controller 180 controls the display unit 151 to fully output the third preview image 513 configuring the third thumbnail image 533.

On the other hand, when a touch is applied to one area of the control screen information 500, in which the thumbnail image is not output (2), the controller 180 controls the display unit 151 to output only the control screen information 500 except for the first to fourth thumbnail images 531, 532, 533, and 533. In this case, the controller 180 may control the display unit 151 to output the third preview image 513, in response to a specific touch applied to an area adjacent to the third object S3 of the control screen information 500.

According to this embodiment, the user can receive a plurality of thumbnail images at once by applying a touch to at least two of a plurality of objects.

Referring to FIG. 5E, the controller 180 outputs the fourth thumbnail image 534, in response to a touch applied to the fourth object S4 included in the control screen information 500. In a state in which the fourth thumbnail image 534 is output, the display unit 151 outputs the first thumbnail image 531 when a touch is applied to the first object S1.

The capture icon 601 is output on each of the first and fourth thumbnail images 531 and 534. The controller 180 may control the memory 170 to store at least one of the first and fourth preview images and the control screen information 500, in response to a touch applied to the capture icon 601 in a state where the first and fourth thumbnail images 531 and 534 are output.

For example, when a touch is applied to the capture icon 601 on the fourth thumbnail image 534 which is first output of the first and fourth thumbnail images 531 and 534, the controller 180 may control the memory 170 to store the first and fourth preview images together with the control screen information 500.

Although not illustrated, when a touch is applied to the capture icon 601 on the first thumbnail image 531 output lastly, only the first thumbnail image 531 and the control screen information 500 may be stored.

When the first and fourth thumbnail images and the control screen information 500 are stored together, the display unit 151 may output a merged image 500b of the control screen information with the thumbnail images overlapped thereon. In this case, when a touch is applied to each of the first and fourth thumbnail images and the control screen information 500, the respective images may be fully output on the display unit 151.

Or, a merged image 500c that the fourth thumbnail image 534 is fully output, the first thumbnail image 531 is output on the fourth thumbnail image 534, and the control screen information 500 is output in a form of a thumbnail image on the fourth thumbnail image 534 may be output on the display unit 151. In this case, the merged image 500c may be stored in the memory 170.

Or, the first and fourth thumbnail images 531 and 534 and the control screen information 500 may be output on the display unit 151 in an overlapped state. The controller 180 may change a display order of the first and fourth thumbnail images 531 and 534 and the control screen information 500 by applying a touch on the overlapped merged image 500d.

According to these embodiments, the user can selectively store various types of images output on the display unit 151.

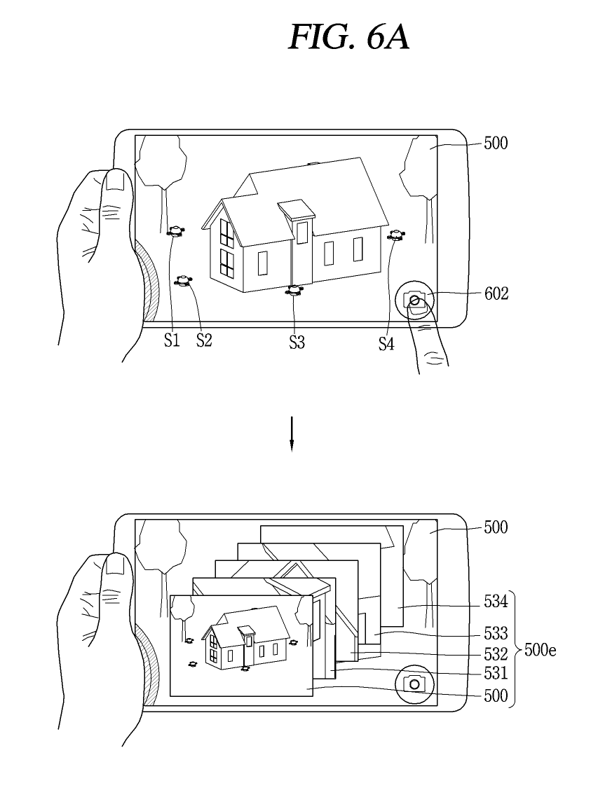

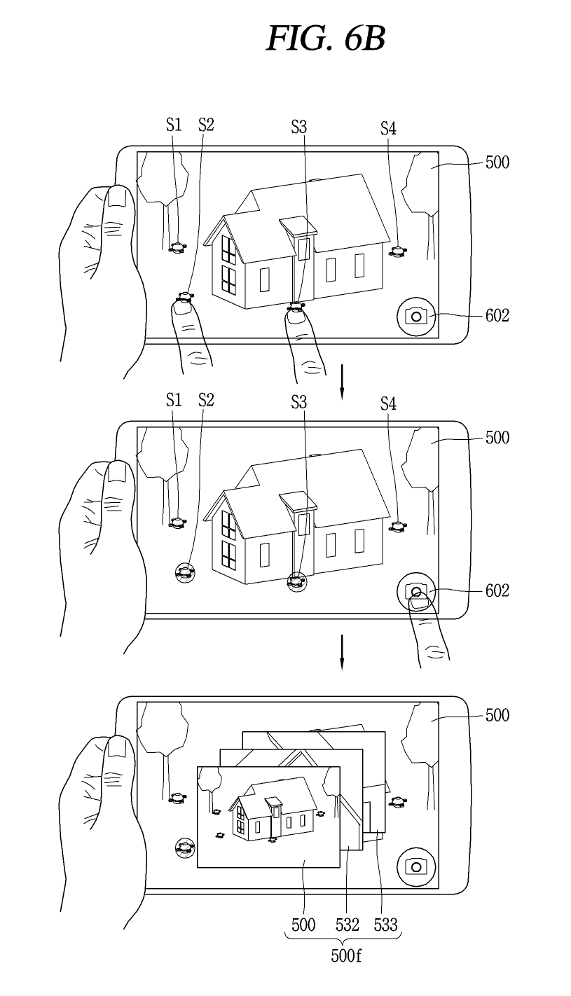

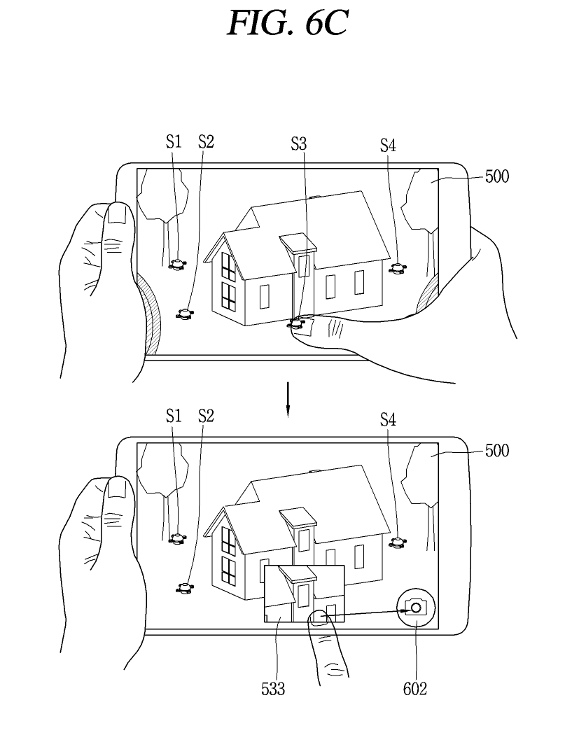

FIGS. 6A to 6C are conceptual views illustrating a control method of capturing images obtained by a plurality of drones according to different embodiments.

Referring to FIG. 6A, the display unit 151 outputs a capture icon 602 on the control screen information 500 including the first to fourth objects S1, S2, S3 and S4. When a touch is applied to the capture icon 602, the controller 180 generates a capture command for capturing the first to fourth preview images 531, 532, 533 and 534 captured by the first to fourth slave drones s1, s2, s3 and s4. The capture command is transmitted to each slave drone by the master drone M.

The display unit 151 may output a merged image 500e in which the first to fourth preview images 531, 532, 533 and 534 and the control screen information 500 overlap together. The controller 180 may control the memory 170 to store each image independently or in the form of the merged image 500e.

According to this embodiment, the user can capture and store images captured by the master drone M and each slave drone at a time, and can acquire a plurality of images captured at the same time point.

Referring to FIG. 6B, when a touch is applied to the second and third objects S2 and S3, the controller 180 may generate a control command for selecting the second and third slave drones s2 and s3. Alternatively, the controller 180 may control the display unit 151 to visually indicate that the second and third objects S2 and S3 have been selected.

When a touch is applied to the capture icon 602 after the second and third objects S2 and S3 are selected, the controller 180 generates a capture control command for controlling the second and third slave drones s2 and s3. The capture control command is simultaneously transmitted to the second and third slave drones s2 and s3 through the master drones M.

The display unit 151 may output a merged image 500f in which the second and third preview images 532 and 533 captured by the second and third slave drones s2 and s3 and the control screen information captured by the master drone M overlap together. Although not illustrated, the second and third preview images 532 and 533 and the control screen information may be stored in the memory 170, respectively or in the form of the merged image 500f

Referring to FIG. 6C, when a touch is applied to one of the plurality of objects in a state where both hands of the user are detected on both ends of the terminal body, the controller 180 controls the display unit 151 to output a preview image captured by a selected slave drone. For example, when a touch is applied to the third object S3 in a state where the both hands are detected, the controller 180 controls the display unit 151 to output the thumbnail image 533 configured as the preview image captured by the third slave drone s3.

In this case, the display unit 151 may output the capture icon 602 for generating the capture control command in one area thereof. The controller 180 may control the memory 170 to store the third thumbnail image 533 when a continuous touch moved after first applied to the third thumbnail image 533 is released from the capture icon 602.

The image stored in the memory 170 may correspond to the image captured by the third slave drone s3 at the time when a touch is first applied to the third object S3, but the present invention is not limited thereto.

According to these embodiments, the user can more easily store a preview image captured by a designated slave drone at a desired time point.

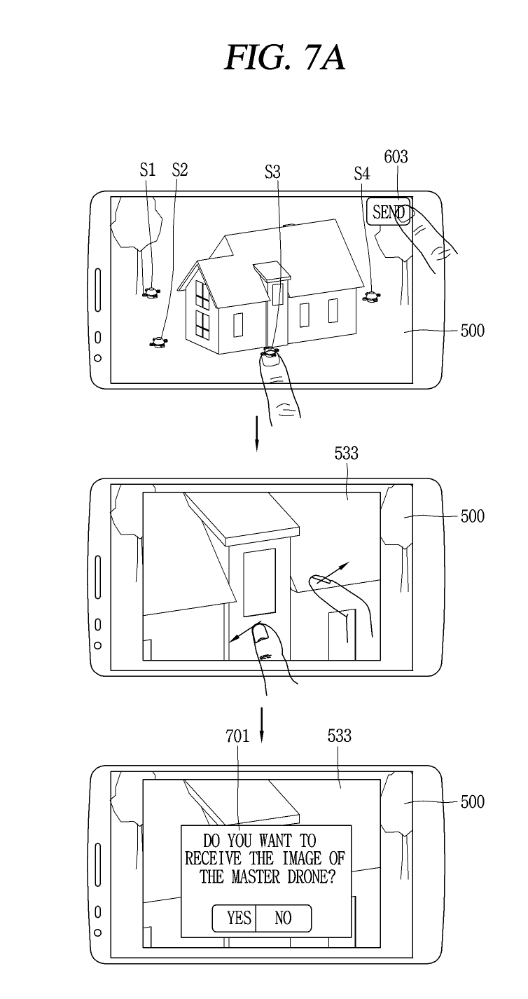

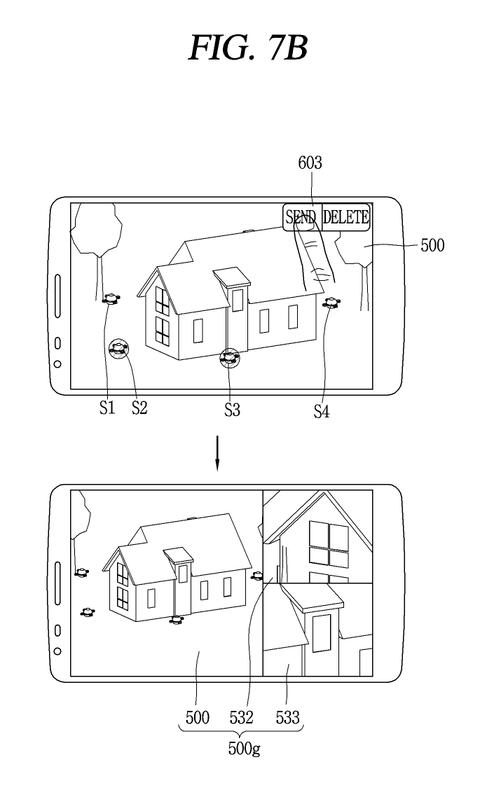

FIGS. 7A and 7B are conceptual views illustrating a control method of sharing an image captured by a slave drone.

Referring to FIG. 7A, when a touch is applied to the third object S3 of the first to fourth objects S1, S2, S3 and S4 displayed on the control screen information 500, the controller 180 controls the display unit 151 to output a control icon 603. The control icon 603 may correspond to an icon generating a control command for sharing (transmitting) a preview image or deleting a stored preview image.

When a touch is applied to a share (transmit) icon of the control icon 603, the controller 180 controls the display unit 151 to output the third preview image 533 captured by the third slave drone s3. The controller 180 may generate a control command for transmitting the third preview image 533 to a specific external device (or a specific server), in response to a specific touch applied to the third preview image 533.

The controller 180 may output a check window 701 for checking whether or not to transmit the control screen information captured by the master drone M together with the third preview image 533.

Referring to FIG. 7B, the controller 180 controls the display unit 151 to output the control icon 603, in response to a touch applied to the second and third objects S2 and S3. Or, the controller 180 may select a part of the plurality of objects after a touch is applied to the control icon 603.

The controller 180 controls the display unit 151 to output the control screen information 500 and the second and third preview images 532 and 532 in divided areas of the display unit 151, in response to a touch applied to the control icon 603. The divided shape of the display unit 151 is not limited to that illustrated in the drawing.

The controller 180 may control the memory 170 to store the control screen information 500 output on the display unit 151 and a merged image 500g including the second and third preview images 532 and 533. Although not illustrated, the controller 180 may change the divided areas of the display unit 151 based on a touch applied to the merged image 500g.

According to this embodiment, the user can more easily store images obtained by a plurality of drones.

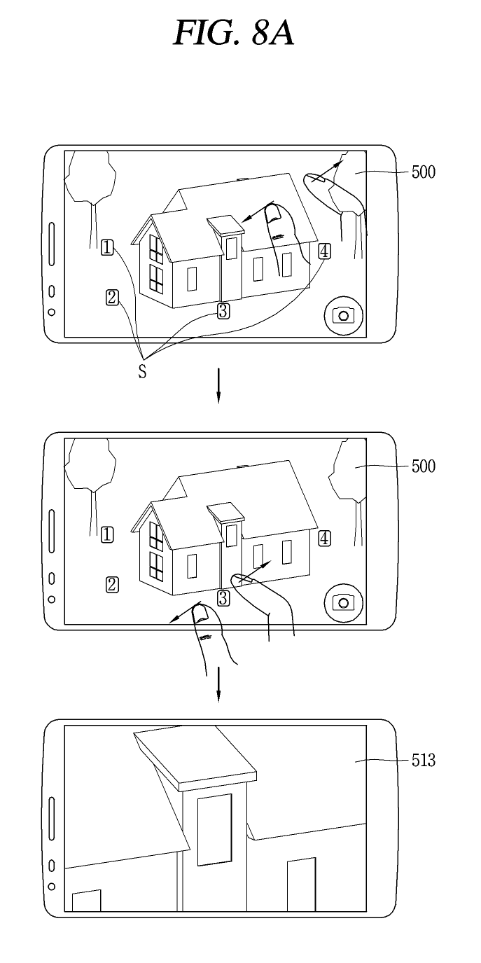

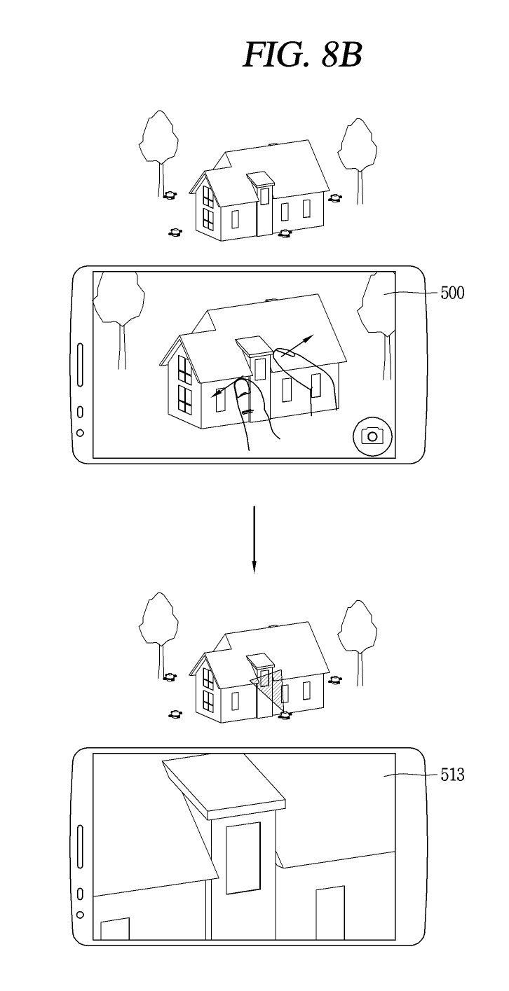

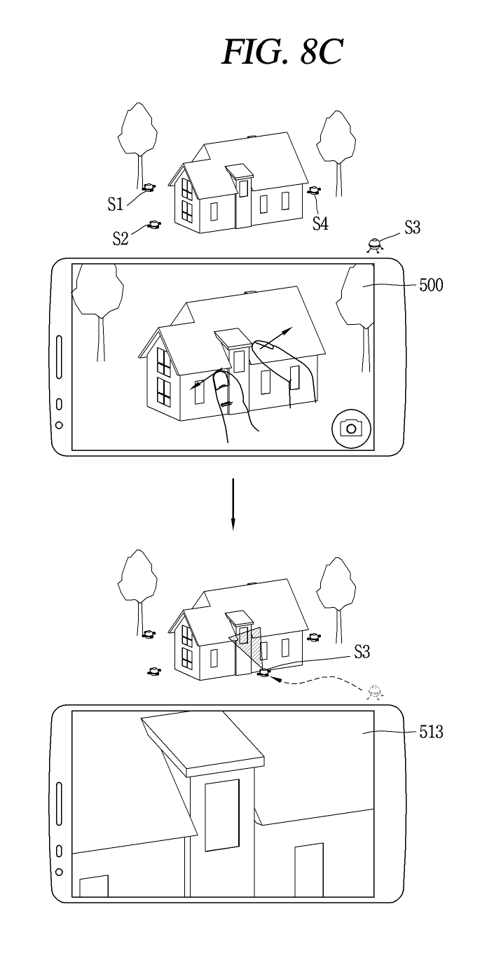

FIGS. 8A to 8C are conceptual views illustrating a control method of outputting a preview image in accordance with different embodiments.

Referring to FIG. 8A, the control screen information 500 output on the display unit 151 includes tags S corresponding to a plurality of slave drones. The tags S may include information for distinguishing the plurality of slave drones, respectively, but is not limited thereto. The tags S indicate positions of the slave drones on the control screen information 500.

Specifically, the controller 180 outputs a merged image on the display unit 151 by converting shapes of the slave drones captured by the master drone M into images captured by the slave drones.

The controller 180 selects one of the plurality of slave drones based on a specific touch input applied to the control screen information 500, and controls the display unit 151 to output a preview image 533 captured by the selected slave drone.

For example, the specific touch input corresponds to a pinch-out touch input of moving in opposite directions. The pinch-out touch input may be substantially the same as a control command for outputting one area of arbitrary screen information in an enlarging manner when the arbitrary screen information is output.

The specific touch input is ignored when a slave drone is not located in an area to which the specific touch input is applied. In this case, the controller 180 may output warning information indicating that the image enlarged by the specific touch input cannot be output. When a slave drone is located in the area to which the specific touch input is applied, the controller 180 controls the display unit 151 to output a preview image 513 captured by the slave drone.

That is, the user can receive a preview image taken by a specific slave drone by inputting a touch input for enlarging an image.

Referring to FIG. 8B, the cameras of the plurality of slave drones may be in an inactive state. The display unit 151 outputs the control screen information 500 captured by the master drone M. The control screen information 500 may not include the objects of the slave drones, but the present invention is not limited thereto.

The controller 180 selects at least one of the plurality of slave drones based on a specific touch applied to the display unit 151. For example, when the specific touch corresponds to a multi-touch input applied to two points on the display unit 151, the controller 180 selects a slave drone located between two points on the control screen information 500. The controller 180 generates a control command for controlling the selected slave drone when a pinch-out touch is applied to a direction that the two points are getting farther away from each other. The control command is transmitted to the selected slave drone by the master drone M.

For example, the control command may correspond to a control command for activating the camera of the selected slave drone. The controller 180 controls the display unit 151 to output the preview image 513 taken by the selected slave drone through the master drone M.

According to this embodiment, the cameras of the slave drones can be activated in a state in which the slave drones are disposed at suitable positions.

Referring to FIG. 8C, when a specific touch is applied to the control screen information 500, the controller 180 transmits location information regarding the touch applied to the control screen information 500 to the master drone M.

The master drone M may select any one of the plurality of slave drones based on the location information. However, when there is no slave drone corresponding to the location information, the master drone M may control one of the slave drones to fly to a position corresponding to the location information. The slave drone flying based on the location information may be a waiting slave drone or another slave drone flying over an area adjacent to the position.

According to this embodiment, even when any slave drone is not disposed at a user-desired position, the user can arrange a slave drone easily based on a touch applied to control screen information, and receive a preview image of a desired position.

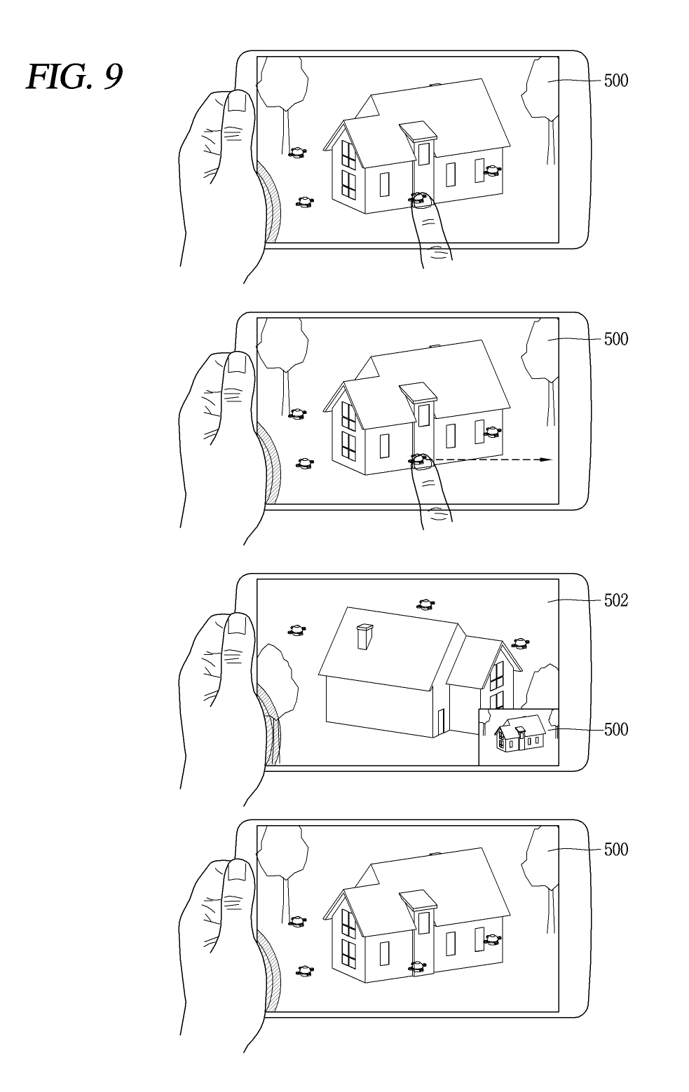

FIG. 9 is a conceptual view illustrating a method of controlling a slave drone to fly over an area outside a capture range of the master drone M.

The control screen information 500 is an image captured by the camera of the master drone M. The control screen information 500 includes objects of the plurality of slave drones.

When a touch is applied to one object of the control screen information 500, the controller 180 may control a flight of a slave drone corresponding to the object. For example, the controller 180 may generate a flight control command for controlling the slave drone such that the slave drone can fly around an obstacle included in the control screen information 500. The controller 180 may generate a flight control command such that the selected slave drone flies along a specific route. In this case, the specific route may not be detected by the camera of the master drone M.

The display unit 151 outputs an image 502 which is captured by the slave drone during the flight. The image 502 may be transmitted through the master drones M. The display unit 151 may output the control screen information 500 on one area of the image 502.

The master drone M transmits the location information related to the slave drone to the mobile terminal when the slave drone returns to its original position, and the display unit 151 may output the control screen information 500 again.

According to this embodiment, when it is desired to capture an area that the master drone M cannot detect, the slave drone can be controlled to fly to a desired area.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

### INDUSTRIAL APPLICABILITY

The present invention relates to a mobile terminal, and provides a control method of allowing a user to recognize a position of a slave drone captured by a master drone and providing a preview image captured at the position of the slave drone. Therefore, the present invention can be utilized in various related industrial fields.

1. A mobile terminal wirelessly connected to a master drone for imaging an external environment including a plurality of slave drones each having a camera, the terminal comprising:
a wireless receiver configured to receive control screen information including an image of the external environment;
a display configured to output the control screen information; and
a controller configured to transmit to the master drone a control command for controlling a selected target slave drone among the plurality of slave drones, in response to a touch applied to the control screen information,
wherein the controller receives a preview image captured by the target slave drone on the basis of the control command, and outputs the preview image on the display.

2. The terminal of claim 1, further comprising:
a terminal body having the display mounted on one surface thereof; and
a pair of sensors disposed on both ends of the terminal body and configured to detect a user's hand supporting the terminal body, and
wherein the controller generates a different control command based on the user's hand detected by the pair of sensors and a touch applied on the control screen information.

3. The terminal of claim 2, wherein the controller generates a flight control command for causing the selected target slave drone to fly to a specific position based on the control command when the user's hand is detected by one of the pair of sensors.

4. The terminal of claim 1, wherein the control screen information includes a plurality of objects corresponding to the plurality of slave drones, and
wherein the display displays, on a target object corresponding to the target slave drone, a thumbnail image that overlaps one area of the control screen information and is configured as the preview image.

5. The terminal of claim 4, wherein the controller generates a flight control command of the target slave drone based on a touch moved after first applied to the thumbnail image.

6. The terminal of claim 1, wherein the display displays information related to the target slave drone on the preview image, and
wherein the controller controls the display to output another preview image captured by another slave drone, in response to a touch applied on the preview image.

7. The terminal of claim 6, wherein the controller controls the display to switch the preview image to the control screen information when a continuous touch is applied to the preview image in a specific direction.

8. The terminal of claim 1, wherein the display outputs a capture icon on the preview image, and
wherein the controller stores at least one of the preview image and the control screen information in a memory, in response to a touch applied on the capture icon.

9. The terminal of claim 8, wherein the controller stores a merged image of the preview image displayed on one area of the control screen information in the memory.

10. The terminal of claim 8, wherein the display outputs the preview image and the control screen information in an overlapping manner, and
wherein the controller controls the display to output the preview image and the control screen information in an intersecting manner, in response to a touch applied on the display.

11. The terminal of claim 2, wherein the controller generates a flight control command of the slave drone based on location information selected in response to a touch applied on the control screen information.

12. The terminal of claim 1, wherein the target slave drone is selected based on a specific touch input applied to enlarge one area of the control screen information.

13. The terminal of claim 12, wherein the controller generates a flight control command for controlling at least one of the plurality of slave drones to move to one area of the external environment corresponding to a touch point on the control screen information to which the specific touch input has been applied.

14. A method for controlling a mobile terminal, the method comprising:
performing a wireless connection with a master drone for imaging an external environment including a plurality of slave drones each having a camera;
receiving control screen information including an image of the external environment;
outputting the control screen information on a display of the mobile terminal;
transmitting, to the master drone, a control command for controlling a selected target slave drone among the plurality of slave drones, in response to a touch applied to the control screen information; and
receiving a preview image captured by the target slave drone on the basis of the control command and outputting the preview image on the display.

15. The method of claim 14, further comprising storing at least one of the preview image and the control screen information based on a touch applied on the display.
